(19) United States
(12) Patent Application Publication
(10) Pub. No.: US 2005/0243739 A1
(43) Pub. Date: Nov. 3, 2005

(54) NETWORK TOPOLOGY DISCOVERY

(75) Inventors: Keith W. Anderson, Wayland, MI (US); Peter Weichhold, Rosstal (DE); Christopher S. Simon, Artarmon (AU)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: RAPISTAN SYSTEMS ADVERTISING CORP., Grand Rapids, MI (US)

(21) Appl. No.: 10/907,929

(22) Filed: Apr. 21, 2005

Related U.S. Application Data
(60) Provisional application No. 60/566,470, filed on Apr. 29, 2004.

(51) Int. Cl. H04L 12/26

(52) U.S. Cl. 370/254

(57) ABSTRACT

A method of assigning device identification in a switched network, and the resulting switched network, includes designing a network having a design topology made up of network devices, constructing a network from the designed network and discovering the actual topology of the constructed network. The discovered topology is compared with the design topology to assign identifications to network devices of the constructed network.

### CROSS REFERENCE TO RELATED APPLICATION

This application claims priority from U.S. provisional patent application Ser. No. 60/566,470, filed on Apr. 29, 2004, the disclosure of which is hereby incorporated herein by reference in its entirety.

### BACKGROUND OF THE INVENTION

The present invention is directed to switched computer networks and, more particularly, to configurating such a network. While the invention has many applications, it is advantageously used with material-handling systems. An example of a switched computer network includes Ethernet networks.

Large material-handling systems may be made up of a number of individual material-handling components each having a network device. An example of such a system is disclosed in commonly assigned International Publication No. WO 2004/067416 A1, entitled INTEGRATED CONVEYOR BED. Especially in large installations, the number of network devices can be extremely large. The network devices may, advantageously, be configured in a B-Tree configuration with one or more multi-port devices, such as field switches, and many dual-port and single-port devices. One or more management computers or servers manage the network. Each network device requires an identifying address, such as an IP address. Commonly, such addresses are assigned by either dipswitches at the network device or by using a special purpose computer connected sequentially with each network device to assign it an address. Such a system is cumbersome, time-consuming and prone to errors.

While auto-addressing systems have been proposed, they have been limited to small systems in which the devices are connected to a common bus in a simple configuration. Such auto-addressing systems are of limited capability and thereby not well adapted for very large systems.

### SUMMARY OF THE INVENTION

The present invention is directed to a technique for discovering the topology of network structures.

A switched network and a method of assigning device identifications in a switched network, according to an aspect of the invention, includes designing a network having a designed topology made up of network devices. Each of the network devices has an assigned identification. A network is constructed from the designed network. The actual topology of the constructed network is discovered, such as with a detection device. The discovered topology is compared with the design topology and identifications are assigned to network devices of the constructed network as a function of the comparing.

A switched network and method of discovering the topology of a switched network, according to another aspect of the invention, includes providing a detection device connected with one of the network devices and discovering with the detection device the topology of the network. This may be accomplished by a) disabling ports of network devices from forwarding messages, b) sending an identify command and receiving a response to identify a high level network device, c) enabling the sending of messages from one port of the identified network device, and d) sending an identify command and receiving a response to identify any network device responding to the identify command sent from the one port of the identified device. Elements c) and d) may be repeated for additional ports of the discovered additional network devices in order to discover yet additional network devices.

A switched network and method of discovering the topology of a switched network, according to an additional aspect of the invention, includes providing a plurality of network devices configured in a particular topology. The network devices include a plurality of multi-port network devices and a plurality of dual-port network devices. The topology of multi-port network devices is discovered, such as with a detection device connected with one of the network devices. Strings of dual-port network devices at ports of multi-port devices are discovered, such as with the detection devices.

These and other objects, advantages and features of this invention will become apparent upon review of the following specification in conjunction with the drawings.

### BRIEF DESCRIPTION OF THE DRAWINGS

FIG. 1 is a block diagram of a network topology configuration process, according to the invention;

FIG. 2 is a block diagram illustrating the structure of a B-Tree node, with a single parent and multiple children;

FIG. 3 is a block diagram of a representative network topology;

FIG. 4 is a block diagram illustrating detecting of multi-port device topology;

FIG. 5 is a block diagram illustrating detection of dual-port and single-port device topology;

FIG. 6 is a block diagram of a network topology that has been discovered by a network topology discovery algorithm;

FIG. 7 is a flowchart for a process for discovering the topology of multi-port devices;

FIG. 8 is a flowchart for the process of traversing the multi-port device topology discovered in FIG. 7;

FIG. 9 is a block diagram illustrating a broadcast domain of the region between the discovery server and the first multi-port device;

FIG. 10 is a block diagram illustrating the broadcast domain at a node of a multi-port device;

FIG. 11 is a flowchart illustrating the process for discovering chains of dual-port and single-port devices;

FIG. 12 is a perspective view of a conveyor bed useful with the invention;

FIG. 13 is a block diagram of a material-handling system illustrating network devices and material-handling devices; and

FIG. 14 is a block diagram of a material-handling control system that is useful with the present invention.

### DETAILED DESCRIPTION OF THE PREFERRED EMBODIMENT

The present invention will now be described with reference to the accompanying drawings, wherein the reference numerals in the following written description correspond to like-numbered elements in the several drawings.

Definitions.

As used herein, the following definitions shall apply.

Single-port device means a network device having a single port.

Dual-port device means a network device that theoretically has exactly two exposed ports.

Multi-port device means any network device which has more than two exposed ports.

Network topology refers to the structure of interconnections between nodes or devices. When discussing the topology, devices may also be referred to as “nodes”, since the terminology is more common when discussing large structures like a network, rather than individual devices. For the remainder of the document, “devices” and “nodes” may be used interchangeably.

Process.

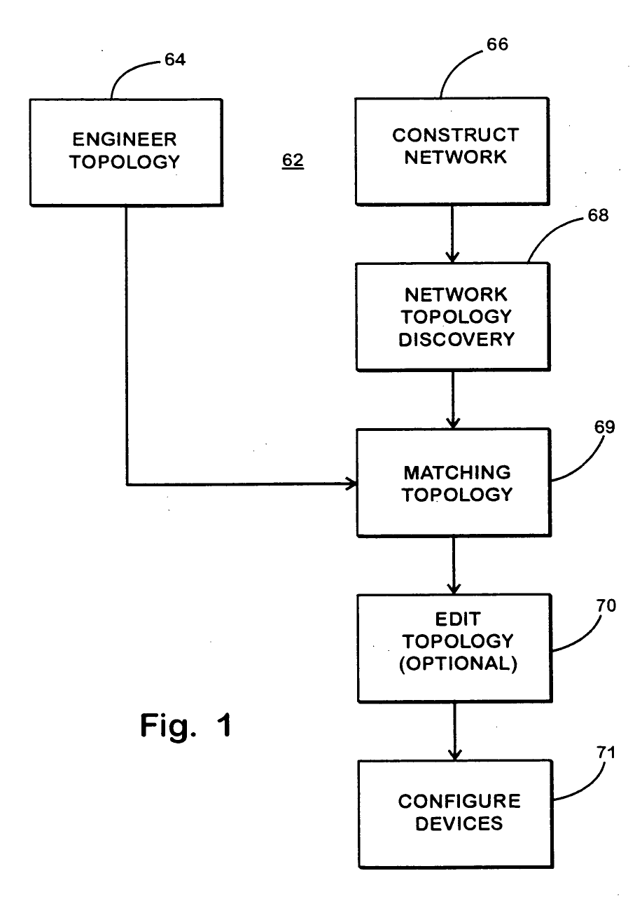

A network topology discovery process 62 compares an engineered topology 64 with a constructed network 66 (FIG. 1). The engineered topology 64 is a configuration file that will have the details of the network devices and their location in the network. Initial configuration parameters, such as the device address for each network device, will be specified in the configuration file. Additionally, a generic template file having the known device types and parameters may be provided for configuring the system. This is to provide a dynamic parameter list for the devices to provide the flexibility to add new device parameters and new device types. The engineered topology may be displayed on the display in the form of a B-Tree structure. The various nodes of the tree represent the network devices.

Topology discovery process 62 includes construction of the network physical topology at 66. The location of a network device is identified using the location identifier from the engineering file. After the network is physically constructed, or modified, a network topology discovery algorithm 68 is performed. The network topology discovery algorithm 68 detects the topological location of all devices in the network as will be discussed in more detail below. When the network topology is discovered, the discovered network topology is matched with the engineering topology at 69. Topology matching is the comparing of nodes in the discovered topology and the engineering topology from the root node onward. All or a subset of the topology may be matched.

Upon completion of topology matching at 69, deviations between the engineered topology and the discovered technology may be reviewed. The physical topology may be altered to correct for wiring errors, or the like. Optionally, the engineered topology may be edited at 70 to match the discovered topology. This may be accomplished by providing an optional topology editing toolbar. The topology editing toolbar may include, by way of example, an “insert button” for providing a function to insert a network device, and a “delete button,” which provides a function for deleting a network device. The toolbar may also provide a “move device” button, which provides a function for moving a network device. Various other buttons may be provided for navigating the engineered topology including “zoom”, “go to”, “expand”, “collapse”, and the like. As the engineered topology is edited, the edited topology is displayed to the operator.

The network devices are then configured at 71 according to the parameters of the matched node in the engineered topology.

Topologies.

A topology discovery algorithm is disclosed that has the ability to discover the topology of network structures. The disclosed algorithm is applicable to devices having at least one exposed port. In the illustrative embodiment, the at least one exposed port is an exposed Ethernet port. The port interface may operate according to a variety of standards, such as 100 BASE-TX, 1000 BASE-T (Gigabit Ethernet over copper), 1000 BASE-SX (Gigabit Ethernet over fiber-optic) or future standards (such as GBASE series), which is designed to be connected in a star or managed ring topology. While the invention has application to a wide variety of network structures, the embodiment of the topology discovery algorithm disclosed herein is illustrated with networks not having loops in the network. However, it is also an implied restriction from the types of devices that are expected in the network—switched networks typically do not contain loops as switching devices provide no mechanism for limiting the endless propagation of broadcast messages. As such, the network itself would not function for its intended purpose, with or without the automatic topology discovery. Occasionally, switches may be connected in a ring, especially with a large network system. In such instance, the operator would be instructed to physically disable, or break, the ring. In the illustrative embodiment, the network does not include any “hubs” or devices that cannot be detected or managed under the defined protocols. However, the invention is useful with networks utilizing switches, such as those operating according to the SNMP protocol. An example of such a switch is a Scalance X400 switch. The Scalance X400 switch has a feature that is useful with the invention, namely, the ability to selectively disable Ethernet broadcast or multicast frame forwarding.

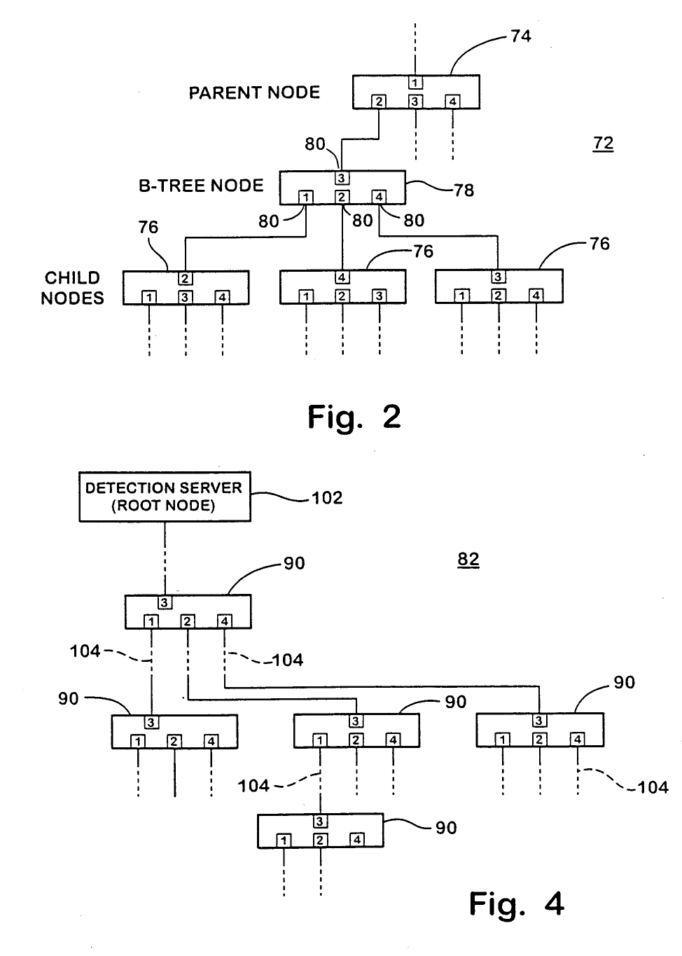

The embodiment of the topology discovery algorithm is disclosed in a manner to discover a classification of devices that can be connected in a network that is represented as a B-Tree structure 72 (FIG. 2). Each node in a B-Tree structure has a single parent node 74 (the node “closer” to the root), and may have multiple child nodes 76 (nodes “further” from the root). An Illustration of the structure of a B-Tree node 78, with a single parent and multiple children can be seen in FIG. 2. FIG. 2 contains an illustration of a B-Tree node 72, demonstrating the relationship with the single parent node 74 and the multiple child nodes 76. Referring to FIG. 2, it can be seen that any of the ports 80 may be connected to the parent node. For a node to exist in the network, it, by definition, has a parent. Therefore, the maximum number of child nodes can be calculated as:
B=N−1

B is the maximum number of child nodes and N is the total number of ports on the device. It will be understood by the skilled artisan that a single-port device cannot have any children, a dual-port device can have up to a single child and a multi-port device can have a varying number of children, depending on the number of ports.

In one example of a network topology that is useful with large material-handling systems, the ratio of dual-port to multi-port network devices may be on the order of 10:1 and the ratio of single-port to dual-port network devices may be on the order of 1:30. In such network, the B-Tree topology will have a significant number of nodes where B=1. That is, “strings” of dual-port network devices will be extremely prevalent.

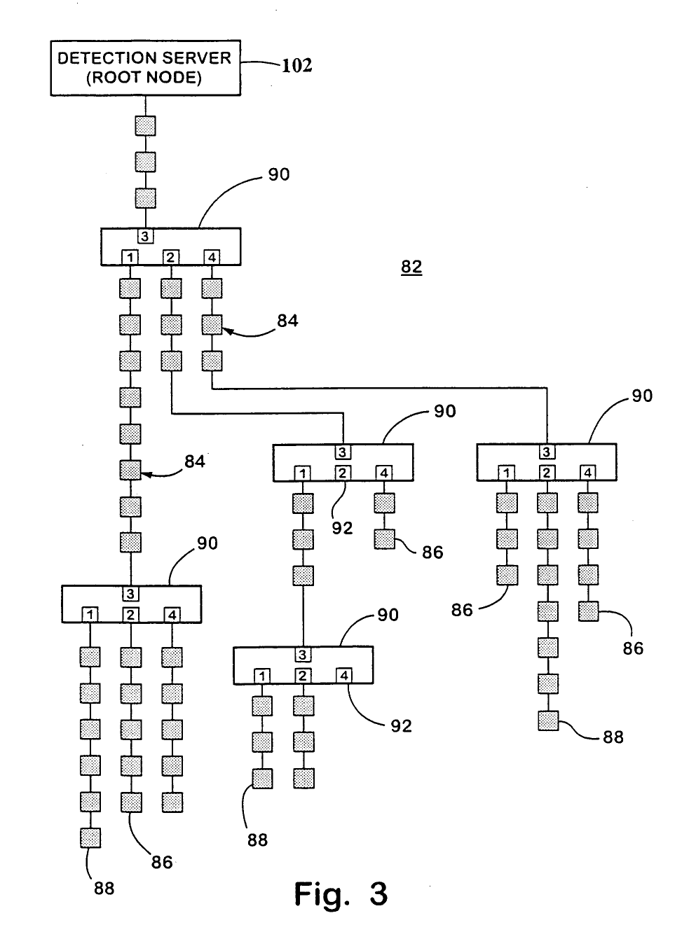

FIG. 3 illustrates a representation 82 of a sample network topology. This network topology is not indicative of the scale of the networks that may be detected, only of the “style” of topology that is expected. Some of the characteristics of the network 82 in FIG. 3 include:
The presence of “strings” or “chains” 84 of dual-port devices between multi-port devices.
The presence of single-port devices 86 at the end of “strings”, with no child nodes.
Some dual-port devices 88 have no children.
Some multi-port devices 90 have no children on some ports 92.

Communication Protocols.

In the illustrative embodiment, a topology discovery algorithm 100 utilizes particular protocols that are used to perform the automatic topology discovery process. The illustrated embodiment utilizes a protocol referred to as Discovery and Basic Configuration (DCP) protocol that is commercially available from Siemens Corp. to be used over Ethernet. DCP protocol is related to Configuration and Discovery 7 (CD7) protocol also marketed by Siemens Corp. for use with commercially available ProfiBUS networks. DCP protocol provides for discovery of the devices that are on the network. The protocol is illustrated with an Ethernet medium in the preferred embodiment.

The DCP protocol utilizes a client-server paradigm. Each device on the network is considered a server hosting a set of databases. A client application can read the data in these databases using a GET command and can write data to these databases using a SET command.

These GET and SET commands are implemented as unicast Ethernet frames. That is, they are sent with a specific MAC address in the destination field. They will not be filtered by switches that are configured to filter broadcasts. The GET and SET commands have arguments, which are used to specify the data item that is to be read or written. The SET command has an additional argument to specify the value that is to be written to the database.

Another DCP command is the IDENTIFY_Request command. It can be sent by the client to all devices on a network using either a broadcast Ethernet frame or a multicast Ethernet frame. Any device that receives the IDENTIFY_Request command should respond with an IDENTIFY Response to the source of the command, depending on the contents of the command's arguments, described below.

The IDENTIFY_Request command has an optional argument which contains a List of Filter protocol data units (PDU) that is used as a filter of responses from devices on the network. These are used to uniquely identify a type of device as “TypeOfStation”. If the List of filter types is present, each device will search the list for the PDU data filter that matches its pre-defined “TypeOfStation” data. The device types found in the PDU list will respond. If the device is not found in the List, it will not respond. If the List is not in the IDENTIFY List of Filter PDU data, every device will respond.

DHCP (Dynamic Host Configuration Protocol) is an industry standard utilized by certain network installations. Its primary purpose is to allow DHCP compliant devices to request and receive TCP/IP configuration information (IP Address, Netmask, etc.). Any device (“host”, in DHCP terminology) that is to be configured via DHCP will send out a DHCP Request when it starts up. The DHCP Request is a Layer 2 broadcast or multicast message. The host will wait for a reply, and if none is received it will retransmit the request. The retransmission time is device-dependent, but is often an exponential back-off.

DHCP relies on the presence of a DHCP server on the network, which listens for these DHCP Requests. When a request is received, the server will decide how the host should be configured. There are a multitude of options for how the server decides on the specific IP Address, but once the server has decided upon an IP Address, a DHCP Allocation message is transmitted back to the host, which should adopt the transmitted TCP/IP configuration.

There are a number of other DHCP-specific features relating to leases, which define how long a particular configuration is valid for, but these are not relevant to the operation of algorithm 100.

SNMP (Simple Network Management Protocol) is an industry standard utilized by certain network installations. Its primary purpose is to allow monitoring and management of SNMP-enabled network devices. These typically include managed switches, routers and other higher-level network devices.

There are three varieties of SNMP presently used in the networking industry:
1. SNMP v1.0
2. SNMP v2.0
3. SNMP v3.0

There are functional differences between SNMP v2.0 and SNMP v3.0. In the illustrative embodiment, the network topology discovery algorithm utilizes functionality provided by SNMP v2.0. Any SNMP compliant device has an SNMP Agent running on it. This SNMP Agent is responsible for communications between the device and an SNMP-based management system.

In general, data is provided by SNMP through MIBs (Management Information Bases) and Traps. MIBs define a set of attributes, including arrays and structures of other attributes. A management system can read or write to these attributes using standard SNMP commands (Get, GetNext and Set). The SNMP Agent is responsible for responding to requests for data and interpreting commands to modify data. Traps are spontaneously issued by the SNMP Agent. They are usually configured to be issued when a physical event occurs. Typical examples include “Link Up” and “Link Down”, which are issued when the status of a physical link changes—i.e., when someone plugs in, or disconnects, an Ethernet device from a network port.

Network Devices.

An example of a typical single-port network device 86 is a personal computer or Notebook computer with a single Network Interface Card (NIC). Single-port devices cannot provide any network switching functionality. The representation of a single-port device is a single line above the box, representing a single port on the device.

In the illustrative embodiment, a single-port device 86 supports the following functions:
Setting of the TCP/IP parameters (IP Address, Netmask, etc.) with a SET command.
Responding to the IDENTIFY_Request command, with support for type-unique List of Filter PDU filtering

Dual-port devices 88 should provide the following standard switched-network related functionality:
If a unicast Ethernet frame is received on any port, it should be forwarded to the port on which the destination MAC (media access control) address can be found. If the device does not know on which port the destination MAC address can be found then the frame should be forwarded to all ports, other than the source port.
If a broadcast or multicast Ethernet frame is received on any port, it should be forwarded to all ports, other than the source port.
The dual-port network device 88 should have the facility to filter the forwarding of broadcast or multicast frames. That is, the device may be instructed to NOT forward broadcast or multicast frames out of the exposed ports.

An example of a typical dual-port network device 88 is the Programmable Bed Controller 108 (PBC), as illustrated in FIGS. 13 and 16 and as described in more detail in commonly assigned U.S. patent application Ser. No. 10/764,962, filed Jan. 26, 2004, by Anderson et al. entitled INTEGRATED BED CONVEYOR, the disclosure of which is hereby incorporated herein by reference.

A dual-port network device 88 is illustrated in this document with a line above the box and a line below the box, representing the two external ports on the device. Port numbers are not numbered because the external ports are treated the same. Because an Ethernet device with only two ports are typically a bridge between two collision domains, in reality dual-port network devices 88 are likely to have a third internal Ethernet port. However, this internal port is irrelevant from the perspective of automatic discovery.

In the illustrative embodiment, a dual-port network device 88 supports the following functions:
Setting of the TCP/IP parameters (IP Address, Netmask, etc.) with a SET command.
Setting of the Broadcast or multicast forward filter configuration parameter for exposed ports with a SET command.
Responding to the IDENTIFY_Request command with support for type-unique List of Filter PDU filtering.

A multi-port network device 90 should provide the following standard switched-network related functionality:
If a unicast Ethernet frame is received on any port of the device, it should be forwarded to the port on which the destination MAC address can be found. If the device does not know on which port the destination MAC address can be found, the frame should be forwarded to all ports, other than the source port.
If a broadcast or multicast Ethernet frame is received on any port, it should be forwarded to all ports, other than the source port.
The device should have the facility to filter the forwarding of broadcast or multicast frames, on a port-by-port basis. That is, the device may be instructed, for example, to only forward broadcast or multicast frames to port 5. Or, it may be instructed to only forward broadcast or multicast frames to ports 3 and 7, or the like. In this manner, the filtering status of each port may be independent of the filtering statuses of other ports.

An example of a typical multi-port device 90 is a field switch that has eight ports. Another example is the commercially available Siemens Modular Switch that has at least 14 ports, but may have up to 26 ports. Yet another example is the Scalance X400 switch available from Siemens Corp.

The multi-port network devices 90 illustrated in FIG. 3 have four ports. The ports are identified by number. The port number located on top of the box is arbitrarily selected based on the position of the device in the topology. Essentially, the port, which is connected to a node closer to the root of the topology, is represented on the top of the box.

In the illustrative embodiment, a multi-port network device 90 supports the following functions:
Setting of the TCP/IP parameters (IP Address, Netmask, etc.) with a SET command.
Setting of the Broadcast or Multicast forward filter configuration parameter for individual ports with a SET command.
Responding to the IDENTIFY_Request command with support for type-unique List of Filter PDU filtering.

A single-port network device may support the standard functionality defined for DHCP compliant hosts. In the illustrative embodiments, dual-port network devices and multi-port network devices are not configured using DHCP.

In the illustrative embodiment, single-port network devices and dual-port network devices are not managed using SNMP. Multi-port network devices should support SNMP management. Specifically, they may support the MIB for Managed Bridges.

The Discovery Algorithm.

In the illustrative embodiment the states of the network devices are as follows prior to execution of network topology discovery algorithm 100:
All devices that support the DCP protocol have the setting “Respond to Identify” turned ON.
All devices that support the DCP protocol have the setting “Broadcast Forwarding” or “Multicast Forwarding” enabled for every port.
All devices that support DHCP should not yet have an IP address allocated and should be in an active DHCP request mode.

The discovery algorithm 100 proceeds in two phases:
Discovery Phase 1. Discovery of the topology of the multi-port network devices.
Discovery Phase 2. Discovery of the topology of dual-port and DCP capable single-port network devices.
Discovery Phase 3. Discovery of the topology of DHCP-capable single-port devices.

The main reason for breaking the algorithm into these three discovery phases in the illustrative embodiment is to mitigate the risk that discovery, or detection, server 102, also identified as the “root node”, may be excessively burdened under the load imposed by attempting to detect all devices at once. However, it is possible that all devices could be discovered at once.

At each phase, the discovery is generally accomplished using a combination of DCP IDENTIFY_Request commands and the facility of devices to disable forwarding of broadcast or multicast messages. The main difference between the first and second phases is that the first phase performs the discovery along the lines of a depth-first tree search while the second phase can assume the existence of a “string” 84 of dual-port network devices.

The network topology discovery algorithm 100 does not make assumptions about the content of the network before, between or after multi-port network devices 90. However, after all multi-port network devices have been detected, it is safe to assume that the topology of the network between multi-port devices 90 may be a single line or string 84 of dual-port network devices.

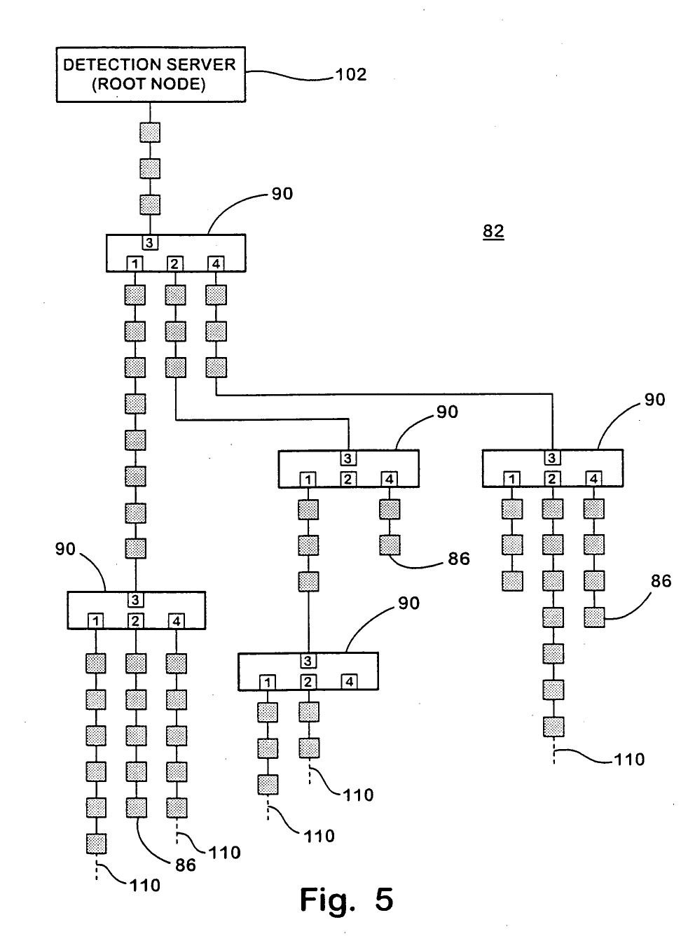

FIG. 4 illustrates the known topology of sample network 82 after discovery phase 1. Dashed lines represent sections 104 that are not yet discovered. FIG. 5 illustrates the known topology of sample network 82 after the initial portion of discovery phase 2. After the initial portion of the second phase, most of the network should be known. Note that the following structures are now completely known:
The structure between the discovery server 102 and the first multi-port device 90.
The structure between all multi-port devices 90.
The structure below some ports of some multi-port devices 90 is now completely known—specifically those ports with a DCP protocol-based single-port device 86 at the end of the string.

Dashed lines 110 in FIG. 5 represent sections that are not yet discovered.

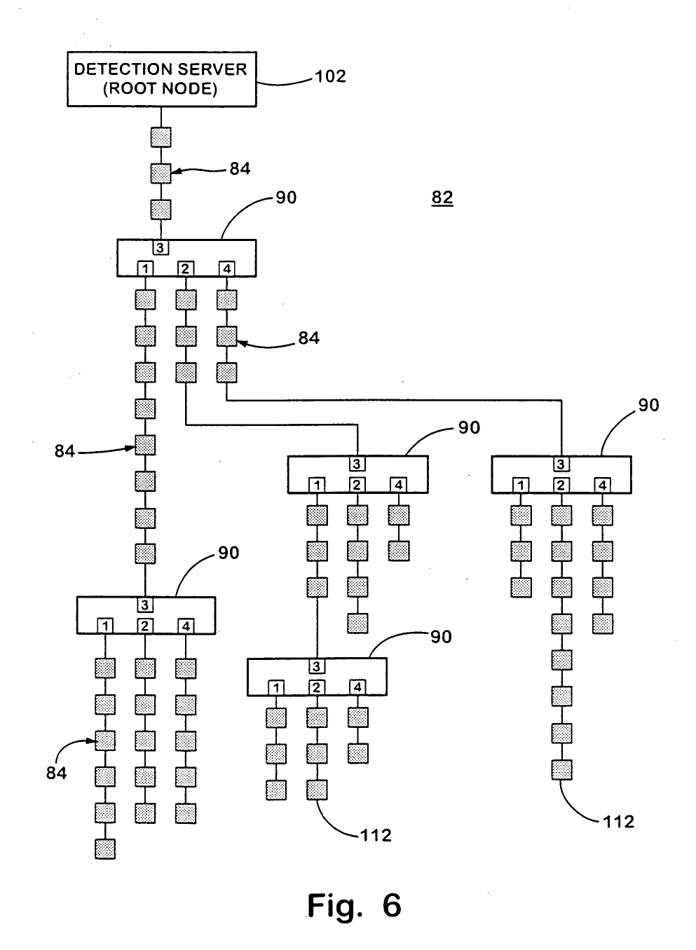

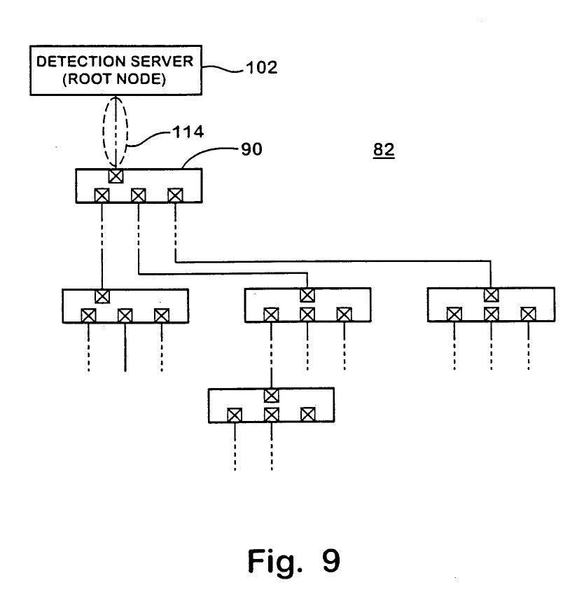

After the third phase, the entire network structure, as shown in FIG. 6, will be known, including two DHCP-based single-port devices 112 that were discovered. It has also been determined that there are no further devices on the other strings of dual-port network devices 84. The entire network has now been discovered.

The steps followed in each phase of algorithm 100 to achieve these outcomes are discussed in more detail in the following sections.

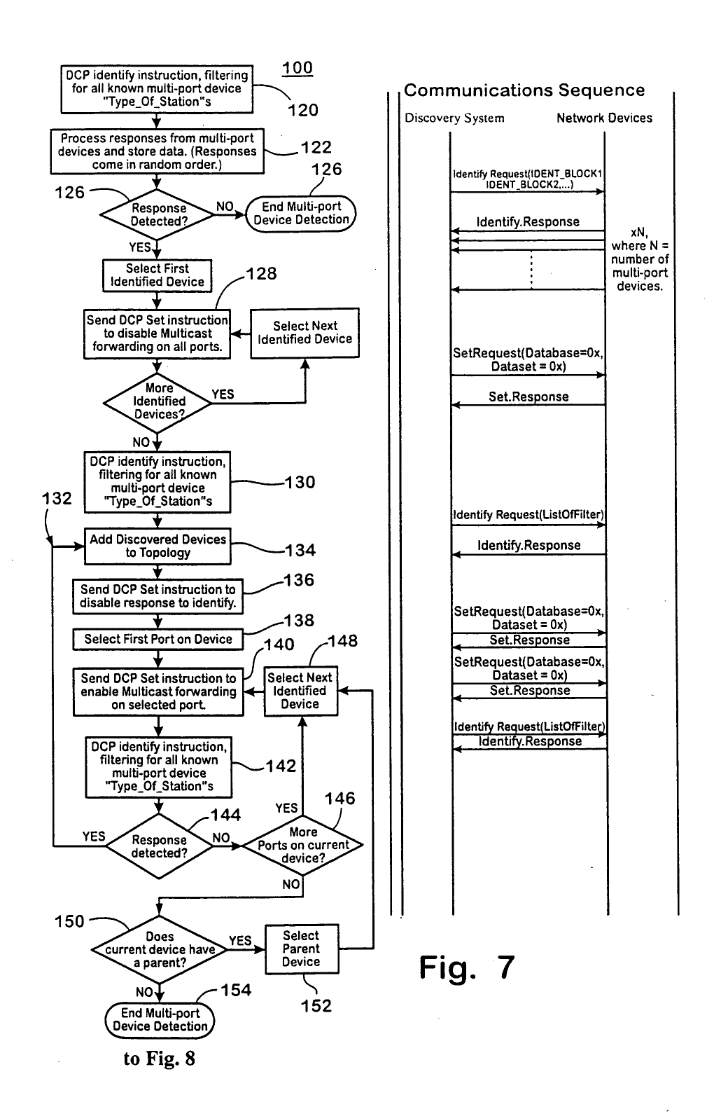

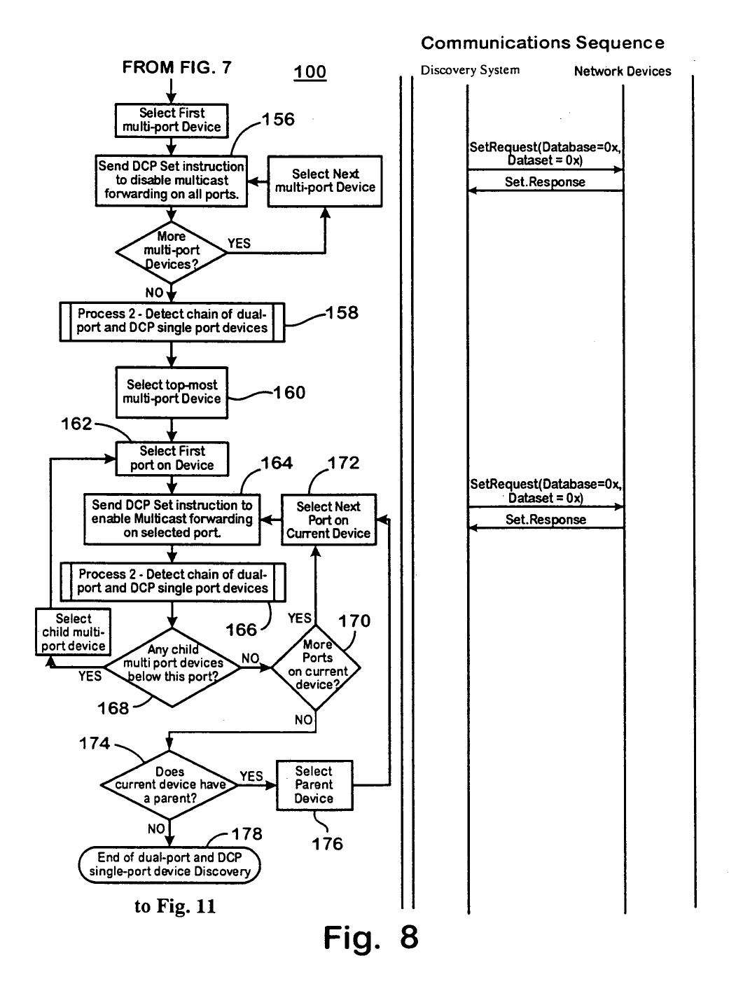

In the illustrative embodiment, detection of the multi-port network device topology uses the filtering capabilities of the IDENTIFY_Request command, and a depth first search of the responding device tree. A flowchart illustrating algorithm 100 is shown in FIGS. 7-11. FIGS. 7-11 also contain a sequence diagram of the communication messages between the discovery system and the network devices to the right of the flowchart showing communication messages corresponding to the flowchart element.

Discovery phase 1 begins with discovery server 102 knowing nothing about the devices on the network. A DCP IDENTIFY_Request message is issued at 120, which is multicast onto the local subnet. Any device on the subnet which has a TypeOfStation that matches any of the List of Filters in the request should respond at 122 with an IDENTIFY_Response message. The List of Filters is created based on the known types of multi-port devices that will respond to the DCP identity. All DCP devices that are not included in the List of Filters will not respond to the DCP IDENTIFY_Request. A DCP IDENTIFY_Request with no data in the List of Filters will provoke an IDENTIFY Response from all DCP devices on the network. Likewise, the IDENTIFY_Request message could be broadcast, which will provoke an IDENTIFY Response from all DCP devices on the network. The responses may come in any order.

After steps 120 and 122, discovery server 104 knows the MAC addresses of every multi-port device on the network 124, but does not know their relative locations—i.e., it does not know the topology. If no response was detected at 126, then the discovery server assumes at 126 there are no multi-port devices and the rest of the segments are ignored.

At 128, a DCP Set_Request message is issued to every one of the devices identified in Segment A. This message is used to disable multicast or broadcast forwarding on all ports of the devices. Every device in the network is now configured to inhibit the forwarding of broadcast messages on all ports.

A DCP IDENTIFY_Request message is issued at 130, which is multicast or broadcast onto the local subnet. Since no multi-port devices will forward the multicast or broadcast message, only the top-most multi-port device will respond. As a result, discovery server 104 knows the MAC address of the top-most multi-port device in the network.

A depth-first search of the network is now carried out. The first step is to add at 134 the devices detected into the topology database. The device is configured at 136 to disable responding to the IDENTIFY_Request with a Set_Request message, and then to allow multicast or broadcast forwarding on the first port at 138 with a second Set_Request message 140. A DCP IDENTIFY_Request message is issued at 142. Since multicast or broadcast forwarding was just enabled, the top-most multi-port device below the current port should respond. If there is no response at 144, then there are no more multi-port devices on this port (146, 148). The port count is incremented and the process proceeds. If there is a response at 144, the newly detected device is added to the topology database at 134 and the procedure is repeated. When all ports on a device have been processed, the algorithm returns to the parent device at 150, 152 and proceeds. If the current network device does not have a parent (150), then the discovery is complete at 154. At the completion of phase 1, discovery server 104 knows the topological location of every multi-port device in the network. The known topology would look something like that in FIG. 4.

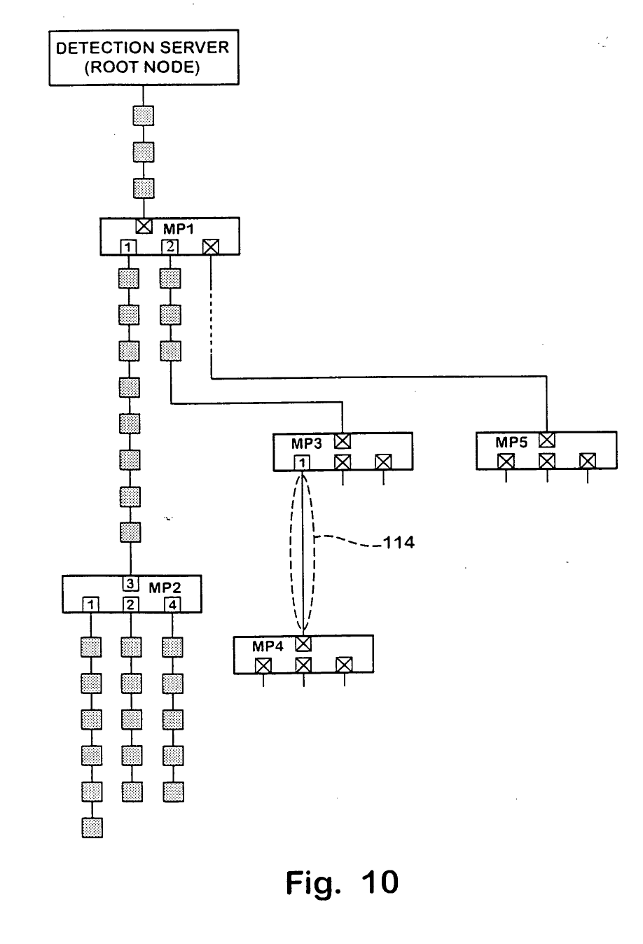

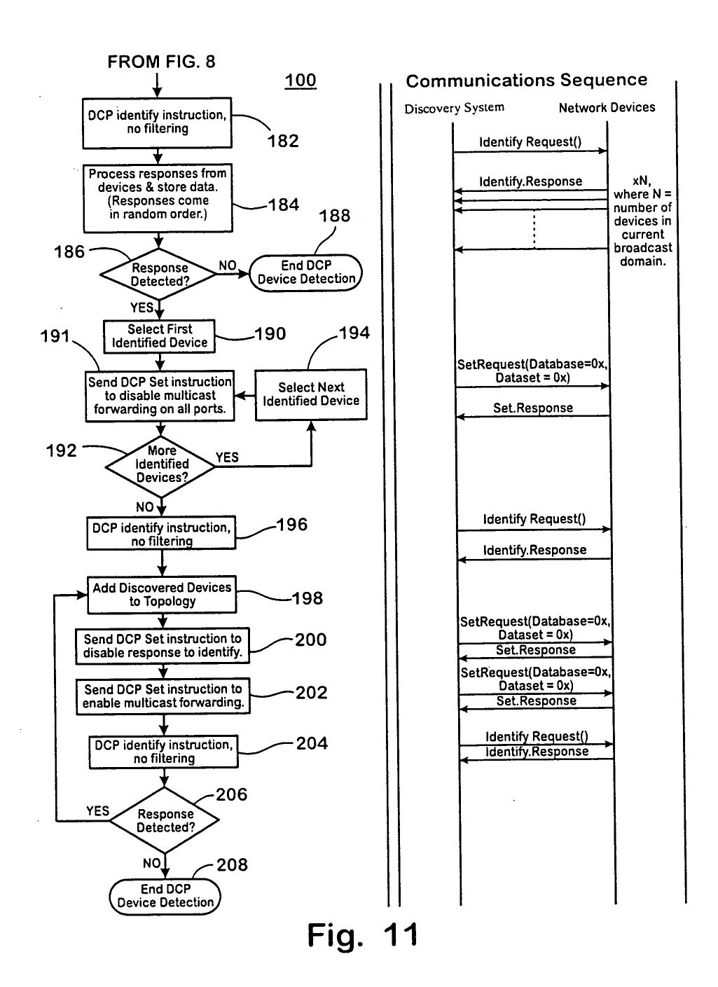

During an initial portion of discovery phase 2, detection of the topology of dual-port devices and DCP single-port devices using DCP protocol relies on traversing the multi-port topology discovered in discovery phase 1, and detecting the potential “chains” of dual-port devices connected to each port of each multi-port device. This is illustrated as two processes. The first process, as illustrated in FIG. 8, is the traversal of the multi-port topology and sequential isolation of various broadcast domains. The second process, as illustrated in FIG. 11, is the detection of a “chain” of network devices in that broadcast domain. The second process is referenced as a sub-process within the discovery phase 2. Broadcast domains is a concept that will be explained in more detail below.

Discovery phase 2 begins with a DCP Set_Request message being issued at 156 to every one of the multi-port devices identified in Phase 1. This message is used to disable multicast or broadcast forwarding on all ports of the devices. The multi-port devices on the network are now configured not to forward multicast or broadcast frames. This creates a multicast or broadcast domain 114 of the region between the discovery server and the first multi-port device (FIG. 9).

In FIG. 9, the crosses are placed on ports which have multicast or broadcast forwarded disabled. As can be seen, all ports on all multi-port devices in the network 82 are blocked. This means that the only portion of the network which will receive a multicast or broadcast message is the space, shown as a dashed ellipse, between the discovery server 102 and the first switch 90. This region is referred to as the current multicast or broadcast domain 114, because it is the only part of the network that will respond to multicasted or broadcasted IDENTIFY_Request messages.

Process 2 of Phase 2 is now called at 158. Since this process is being called in the context of the multicast or broadcast domain set up at 156, the topology between the discovery server and the topmost switch will be discovered. As a result, discovery server 102 knows the entire multi-port device topology, and the dual-port device topology between the discovery server and the topmost multi-port device.

Next, a depth first traversal of the multi-port topology is carried out at 160-178. This process is quite similar to steps 134-154 and will not be repeated. However, while traversing the topology, the current multicast or broadcast domain is modified. By this method, the “chains” of dual-port devices 84 are discovered.

For example, refer to FIG. 10, which illustrates the state of the multicast or broadcast domain when:
The current switch is MP3 and the current port is 1.
The active port on switch MP1 is port 2.
Switch MP2 has been completely discovered.

In FIG. 10, the multicast or broadcast domain 114 is contained within the dashed line. Multicast or broadcast messages will be distributed down to switch MP2, so switch MP2 could be considered as in the current multicast or broadcast domain. However, that portion of the network has already been examined and no further devices will respond from there. Therefore, the current multicast or broadcast domain 114 is the portion of the network currently under investigation.

The upper-most ports on switches MP1 and MP3 are still blocked. This is because those port numbers are greater than the current port on both devices. This is accommodated by the discovery protocol, as blocking multicast or broadcast forwarding on a port only refers to blocking the exit of multicast or broadcast messages on that port.

A flowchart specifying the algorithm for the process of detection of chains of dual-port devices 84 is shown in FIG. 11. The discovery server 102 knows the entire topology above the current broadcast domain 114 and it knows the topology of the multi-port devices below the current broadcast domain 114. The multi-port device below the current port on the current multi-port device has multicast or broadcast forwarding disabled on all ports at 180. A DCP IDENTIFY_Request message is issued at 182, which is multicast or broadcast onto the local subnet. There are no IDENT_BLOCK filters in the IDENTIFY_Request message. All devices in the current multicast or broadcast domain respond with an Identify_Response at 184 and the responses may come in any order. If there are no responses at 186, then it is determined at 188 that there are no devices in the current multicast or broadcast domain. After this segment, discovery server 102 will know the MAC addresses of every device in the current multicast or broadcast domain, but it will not know their sequence.

A DCP Set_Request message is issued at 190-194 to every one of the devices identified in Segment A. This message is used to disable multicast or broadcast forwarding on those devices. All devices in the current broadcast domain now have multicast or broadcast forwarding disabled. A DCP IDENTIFY_Request message is issued at 196. Since all devices have multicast or broadcast forwarding disabled, only the first device in the chain will respond. The discovery server now knows the first device in the chain in the current multicast or broadcast domain. The device discovered at 196 is added to the topology database at 198. The discovered device is configured to disable responding to the IDENTIFY_Request with a Set_Request message at 200, and then to allow multicast or broadcast forwarding on the first port with a second Set_Request message at 202. A DCP Identify-Request message is then issued at 204. Since multicast or broadcast forwarding was just enabled, the next device in the chain should respond. If it is determined at 206 that there is no response, then there are no more devices on this chain at 208. This process is complete. If it is determined at 206 that there is a response, the newly detected device is added to the topology database at 198 and the procedure is repeated.

The discovery server knows the topological location of every device in the current multicast or broadcast domain. The discovery server would now return to the process beginning at step 156 from this phase. The entire network topology of configuration and protocol capable devices is known. There may still be undiscovered DHCP devices 112 in the network. Discovery of DHCP devices may be carried out using data from the MIB for managed bridges available through SNMP. The discovered topology will be similar to that shown in FIG. 3.

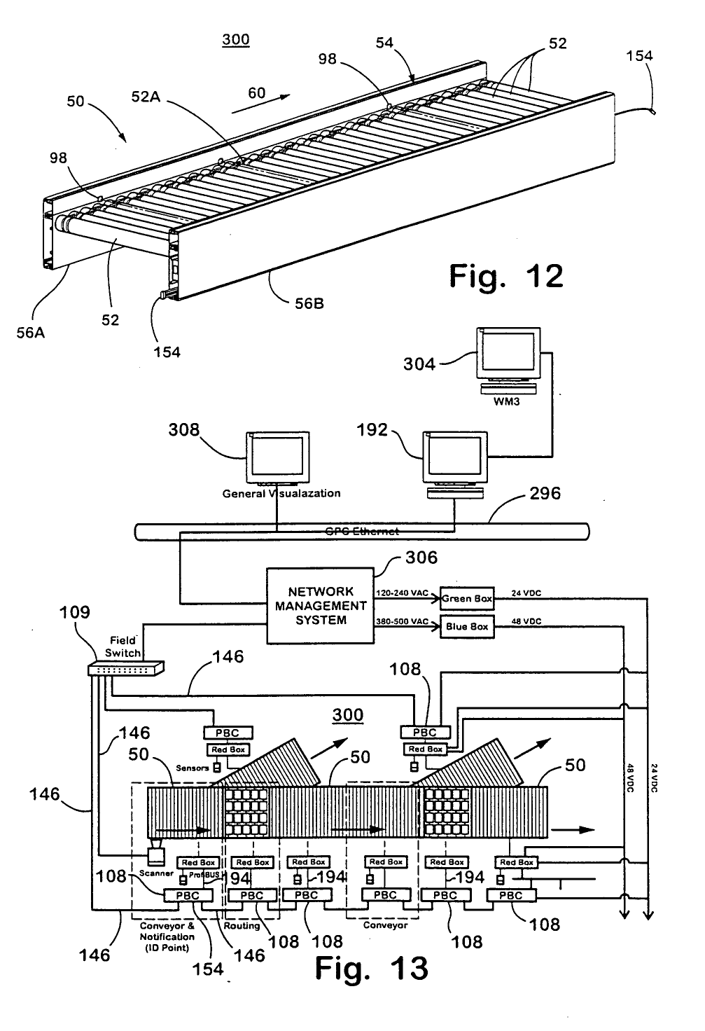

One application for the invention is in a material-handling system 300 made up of a series of components including one or more conveyor beds 50, as depicted in FIG. 12. Conveyor bed 50 may be a modular unit that may be used as part of a conveying system made up of additional modular conveying units. Conveyor bed 50 includes a conveying surface which may be driven by a plurality of rollers 52 that are supported on each of their ends by a frame 54 and driven either through O-rings from a drive, such as a motorized roller, or through an endless member. Frame 54 includes first and second side members 56a and b. Side members 56a and b generally extend the length of conveyor bed 50 in a parallel orientation. The top surfaces of rollers 52 in the illustrated embodiment define a conveying surface 58 on which articles, such as packages, boxes, cartons, or other types, may be placed. The conveying surface may also be defined by belts, or the like. One or more of rollers 52 is powered. In operation, the rotation of the powered rollers causes articles placed on conveying surface 58 to move longitudinally along the length of the conveyor bed generally in a direction of conveyance 60.

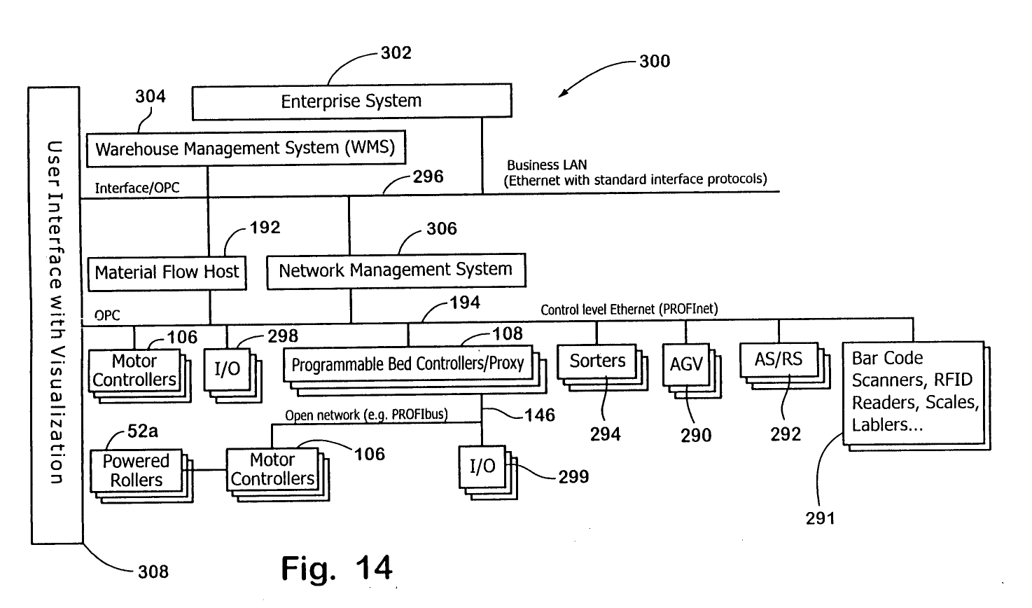

FIGS. 13 and 14 depict a plurality of different control elements that may be present in a material-handling system 300 made up of functional material-handling elements, such as conveyor bed 50. Conveyor bed 50 includes a programmable bed controller 108 (PBC), which is a dual-port network device including a pair of network connections 154 that allow bed controller 108 to be connected to a network 146. The network 146 may be an Ethernet-based network. The network connections 154 connect multiple bed controllers 108 from different conveyor beds 50 together. The network connections further connect bed controllers 108 to a host, such as a material flow host 192, also referred to as an “area controller”, as will be described in more detail herein. Each bed controller 108 is treated as a node on the network, and is assigned a unique communications address which the particular bed controller 108 is responsive to. Bed controller 108 uses the network connections 154 to send communications to other bed controllers 108, as well as to a material flow host 192. A network management system 306, which may perform the function of discovery server 102, may also send communications to the various bed controllers 108. Network 146 is shown including a field switch 109 which is a multiport device. Multiple field switches 109 may be used. Bed controller 108 may further include a network proxy for the Profinet, or other network 194 that allows network 194 to transmit information to communications bus 146. This information may include updates to the framework for the motor controllers, polling of diagnostic data, monitoring of the speed of motors 52a, and monitoring faults, as well as other information.

Changes and modifications in the specifically described embodiments can be carried out without departing from the principles of the invention which is intended to be limited only by the scope of the appended claims, as interpreted according to the principles of patent law including the doctrine of equivalents.

1. A method of assigning device identifications in a switched network, said method comprising:
designing a network having a designed topology made up of network devices, each of said network devices having an assigned identification;
constructing a network from the designed network;
discovering the actual topology of the constructed network; and
comparing the discovered topology with the designed topology and assigning identifications to network devices of the constructed network at least as a function of said comparing.

2. The method of claim 1 wherein said designing a network comprises designing a B-Tree network.

3. The method of claim 1 wherein said designing a network comprises providing tools that perform functions including at least one chosen from inserting a network device, deleting a network device, and moving a network device.

4. The method of claim 1 wherein said network devices include at least multi-port network devices and dual-port network devices and wherein said discovering the actual topology of the network comprises discovering the topology of multi-port network devices and discovering strings of dual-port network devices at ports of a multi-port network device.

5. The method of claim 1 wherein said discovering the actual topology of the network comprises disabling ports of network devices from forwarding messages, sending an identify command and receiving a response to identifying a network device responding to the identify command.

6. The method of claim 5 wherein said disabling ports comprise disabling devices from forwarding multicast or broadcast messages.

7. The method of claim 1 wherein said discovering begins with a root node.

8. The method of claim 1 wherein said discovering comprises discovering a topology of multiport devices then traversing the topology of multiport devices and detecting network devices between multiport devices.

9. The method of claim 8 wherein said detecting devices between multiport devices comprises sequential isolation of multicast or broadcast domains and discovering chains of network devices in each said domain.

10. The method of claim 1 applied to a network defined by network components of a material-handling system.

11. A method of discovering the topology of a switched network, said method comprising:
a) disabling ports of network devices from forwarding messages;
b) discovering a high level network device by sending an identify command and receiving a response to identify any device responding to the identify command;
c) enabling the forwarding of messages from one port of the discovered device;
d) discovering another network device by sending an identify command and receiving a response to identify any device responding to the identify command sent from the one port of the identified device;
e) discovering additional network devices by repeating elements (c) and (d) for additional ports of discovered network devices.

12. The method of claim 9 including inhibiting an identified network device from responding to an identify command.

13. The method of claim 9 wherein said response comprises sending a device address from the network device receiving the identify command.

14. The method of claim 9 including adding identified network devices to a device database.

15. The method of claim 9 including establishing an initial inventory of network devices making up the network by sending an identify command and receiving responses.

16. The method of claim 13 wherein said network devices include at least multi-port network devices and dual-port network devices.

17. The method of claim 111 wherein said disabling ports comprise disabling devices from forwarding multicast or broadcast messages.

18. The method of claim 11 wherein said discovering begins with a root node.

19. The method of claim 11 wherein said discovering comprises discovering a topology of multiport devices then traversing the topology of multiport devices and detecting network devices between multiport devices.

20. The method of claim 19 wherein said detecting devices between multiport devices comprises sequential isolation of multicast or broadcast domains and discovering chains of network devices in each said domain.

21. The method of claim 9 applied to a network defined by network components of a material-handling system.

22. A switched network, comprising:
a plurality of network devices configured in a particular topology;
a detection device connected with one of said network devices;
said detection device discovering said particular topology of said network; and
a comparison function comparing the discovered topology with an electronic file representing a designed topology of the network, said comparison function assigning identifications to network devices of the constructed network at least as a function of said comparing.

23. The network of claim 22 wherein said network topology comprises a B-Tree topology.

24. The network of claim 22 wherein said comparison function includes tools for manipulating said electronic file, said tools including at least one chosen from a function for inserting a network device, a function for deleting a network device, and a function for moving a network device.

25. The network of claim 22 wherein said network devices include at least multi-port network devices and dual-port network devices and wherein said detection device discovers the actual topology of the network by discovering the topology of said multi-port network devices and discovering strings of said dual-port network devices at ports of one of said multi-port network devices.

26. The network of claim 22 wherein said detection device discovers the actual topology of the network by disabling ports of network devices from forwarding messages, sending an identify command and receiving a response to identifying a network device responding to the identify command.

27. The network of claim 26 wherein said detection device disables ports of network devices from forwarding broadcast or multicast messages.

28. The network of claim 22 wherein said detection device connects with a root node of the network.

29. The network of claim 22 wherein said detection device discovers a topology of multiport devices then traverses the topology of the multiport devices and detects network devices between multiport devices.

30. The network of claim 29 wherein said detection device detects network devices between multiport devices and sequentially isolating of multicast or broadcast domains and discovering chains of network devices in each said domain.

31. The network of claim 26 wherein said network devices are network components of a material-handling system.

32. A switched network, comprising:
a plurality of network devices configured in a particular topology; and
a detection device connected with one of said network devices;
said detection device discovering said particular topology of said network by:
a) disabling ports of network devices from forwarding messages;
b) sending an identify command and receiving a response to identify a high level network device;
c) enabling the forwarding of messages from one port of the identified network device;
d) sending an identify command and receiving a response to identify any network device responding to the identify command sent from the one port of the identified device;
e) repeating elements (c) and (d) for additional ports of discovered additional network devices in order to discover additional network devices.

33. The network of claim 32 wherein said detection device inhibits an identified device from responding to an identify command.

34. The network of claim 32 wherein said response comprises sending a device address from the network device receiving the identify command.

35. The network of claim 32 wherein said detection device adds identified devices to a device database.

36. The network of claim 32 wherein said detection device sends an identify command and receives responses in order to initially identify network devices making up the network.

37. The network of claim 36 wherein said network devices include at least multi-port network devices and dual-port network devices.

38. The network of claim 32 wherein said network devices include at least multi-port network devices and dual-port network devices and wherein said detection device discovers the actual topology of the network by discovering the topology of said multi-port network devices and discovering strings of said dual-port network devices at ports of one of said multi-port network devices.

39. The network of claim 32 wherein said detection device discovers the actual topology of the network by disabling ports of network devices from forwarding messages, sending an identify command and receiving a response to identifying a network device responding to the identify command.

40. The network of claim 39 wherein said detection device disables ports of network devices from forwarding broadcast or multicast messages.

41. The network of claim 32 wherein said detection device connects with a root node of the network.

42. The network of claim 32 wherein said detection device discovers a topology of multiport devices then traverses the topology of the multiport devices and detects network devices between multiport devices.

43. The network of claim 42 wherein said detection device detects network devices between multiport devices and sequentially isolating of multicast or broadcast domains and discovering chains of network devices in each said domain.

44. The network of claim 34 wherein said network devices are network components of a material-handling system.
